(19) United States
(12) Patent Application Publication
(10) Pub. No.: US 2010/0215888 A1
(43) Pub. Date: Aug. 26, 2010

(54) BORDER

(76) Inventors: Ronald Horsman, West Yorkshire (GB); Honora Horsman, West Yorkshire (GB)

Correspondence Address: FAY SHARPE LLP, 1228 Euclid Avenue, 5th Floor, The Halle Building, Cleveland, OH, 44115, US

(21) Appl. No.: 12/601,412

(22) PCT Filed: May 23, 2008
(86) PCT No.: PCT/GB2008/001784

§ 371 Date: Apr. 21, 2010

(30) Foreign Application Priority Data
May 23, 2007 (GB) 0709964.1

(51) Int. Cl. B32B 7/04; B29C 47/00; B32B 37/00

(52) U.S. Cl. 428/57; 156/244.11; 156/242

(57) ABSTRACT

A border or beading article for use as beading, coving, dado rails and architraves and the like, and/or as a protective border for objects. The border including two or more members joined together at an angle. Said border can be easily cut with a knife and/or scissors to substantially provide one or more internal and/or external angles required to form said border.

This application relates to the provision of borders for use as beading, coving, dado rails and architraves and the like.

Although the following description refers to borders for use in the above applications, particularly beading for laminate flooring, to decorate or disguise the join where one surface meets another adjacent surface, it will be appreciated by persons skilled in the art that a border in accordance with the invention can be used for decorative as well as functional purposes, for example preventing injury by bordering a hard object such as a table or the like.

The use of flexible materials to produce borders such as architraves, beading and the like is known. Typically these types of borders are used when one surface, such as a laminate floor, meets another surface, such as a skirting board, wall or doorframe. The border, such as beading, is used to decorate the join between the surfaces and/or to cover the expansion gap left between the surfaces. Fitting the beading where required, particularly in the home, presents a number of problems. Firstly, because the borders are supplied in lengths they have to be cut to fit around the corners of a room. Typically a mitre saw or block is used so that the user can cut the length to the required angle, however this can be problematic in working out which angles to cut for ‘interior’ and ‘exterior’ corners and in addition using a saw itself, or in combination with a mitre block, can present problems to those not used to power-tools and/or DIY.

Another problem can arise as frequently the interior and exterior corners in a room are close to, but not exactly 90°. Therefore, adjustments have to be made to the mitre and new angles calculated and cut.

Also, when fitting beading for laminate flooring it is very difficult to fit the beading around the bottom portion of a doorframe. As doorframes or door architraves typically have a number of angled surfaces, the beading normally has to be cut a number of times to achieve a close fit. This is a particularly difficult task even for the most proficient laminate floor fitters.

Another problem is that the door itself can very often contact the beading when fully open. When relatively inflexible beading is used it frequently dents, cracks or can be forced away from the surface to which it is attached. This is also a problem if the beading goes into the doorframe itself as it can be damaged when the door is closed. In the worst cases the door itself can become unhinged.

Another problem with fixing borders to surfaces is that they need to be glued and/or nailed into position. This can be a very messy and time-consuming task.

A yet further problem is that typically the beading is supplied in a colour and/or texture that does not match the colour and or texture effect of the adjacent surfaces to which it is to be attached. This is particularly noticeable with coloured walls and wood effect laminate flooring.

It is therefore an aim of the present invention to provide an article, which can be used as a border, to overcome the abovementioned problems.

It is a further aim of the present invention to provide a method of producing such a border, which overcomes the aforementioned problems.

In a first aspect of the invention there is provided a beading or border article, said article including at least two substantially linear members, wherein said members are joined together such that the angle between said members is other than 180°.

In one embodiment the members and article are provided with sufficient flexibility so as to be manipulable by a user of the article when fitting the same as a border or beading.

Typically the members are formed integrally at the time of forming the article. Alternatively the members are joined together by a further component which lies between and joins the ends of the respective members at the desired angle. Typically the join between the members forms an apex of the article.

Typically there are three members included in an article, a central member joined at one end to a first peripheral member having a first angle therebetween and the second peripheral member joined to the other end of the central member having a second angle therebetween.

In one embodiment the first angle between the central member and the first peripheral member is substantially 90° and the second angle between the central member and the second peripheral member is substantially 270°. Alternatively the first angle is substantially 270° and the second angle is substantially 90°.

In one embodiment the first angle forms an external angle and the second angle forms an internal angle or vice-versa.

In one embodiment the article includes at least one external facing surface and at least one internal facing surface. Typically the at least one external surfaces are exposed in use and the internal surfaces are not exposed in use.

Typically at least a portion of one of the internal surfaces is substantially in contact with the surface onto which the article is to be attached.

In one embodiment the external surface includes at least one curve and/or bevel running substantially along the length thereof. Typically the curved and/or bevelled surface gives the article the appearance of beading and/or coving and/or dado rails and/or door or window architraves or the like. Typically this makes the articles a suitable replacement for any length of wood, fibre board or plaster used for functional and/or decorative effect when substantially covering and/or disguising the join between two or more adjacent surfaces.

In one embodiment the curved and/or bevelled surface is the external surface of the article when fitted in position. Typically the first angle between the central member and the first peripheral member is the internal and/or external angle of beading and/or coving and/or dado rails and/or door or window architraves or the like and the second angle is the other of the external or internal angle opposite to that of the first angle.

Typically the article can be used to decorate around the circumference of a room, particularly where one surface meets another to substantially hide a gap and/or for aesthetic purposes.

By having at least one internal angle and/or one external angle on the article this removes the need for a user to have to make mitre saw cuts for the internal or external angles in their house. As the article is flexible the same can fit tightly to the corners of the room even though the wall and or surfaces may not be level or straight and/or the corners not 90° internal or external corners.

In one embodiment the article is resiliently biased to the condition in which it was originally formed. Typically if the article is formed with two right angles and is subsequently manipulated to another angle and/or shape once released said article substantially returns to its original formed condition.

Typically the article can be cut to the required length with a pair of scissors or a knife and the like.

In one embodiment the unattached free or distal ends of the members are tapered. Typically the unattached ends are tapered to form a smooth rounded end.

In one embodiment at least a portion of the article has an adhesive material attached thereto. Typically the internal surface of the article includes an adhesive strip and/or layer to facilitate the securing of the article to at least one surface in use.

In one embodiment the adhesive strip is of a Velcro-type (trade mark) hook and loop fastening.

In one embodiment the article is detachably attached by the adhesive strip in use. Typically the use of the adhesive strip removes the need for nails or glue and the article can be detached and reattached at will.

In one embodiment the article has a simulated wooden texture and/or colouring. Typically the wood effect includes one or more ridges which give the article the appearance of real wood.

In one embodiment the article is made substantially from rubber. Typically the article comprises rubber and at least one other material.

In one embodiment the article comprises rubber and fire resistant/retardant material. Typically the article comprises 70%-90% rubber and 10%-30% fire resistant/retardant material. Typically the resistant/retardant material is fire resistant/retardant powder and/or fluid.

In one embodiment the 10%-30% fire resistant/retardant material includes two or more fire resistant/retardant materials. Typically the fire resistant/retardant materials are substantially 90% Cetaflam™ 313 and substantially 10% Cetaflam™ 226.

In one embodiment the fire resistant/retardant materials have the advantage of substantially thickening the mixture of materials used in forming the article.

In one embodiment the fire resistant/retardant materials render a substantially transparent mixture of materials, used in forming the article, substantially opaque.

In one embodiment the rubber is natural rubber, in an alternative embodiment the rubber is synthetic rubber or a mixture of synthetic and natural rubbers.

In one embodiment the article includes 0-30% wood fibre.

In one embodiment the article includes 0-30% nut shell flour.

In one embodiment the article includes 0-30% hessian.

In one embodiment the article includes one or more dyes and/or colourings. The dyes and/or colourings can be provided to colour the article to allow it to match and/or blend in with the intended situation of the article. For example the article may be coloured white if it is to be used as ceiling coving or red to match an adjacent wall colour if it is to be used as a dado rail. Typically the article is brown in colour or a simulated wooden colouring.

In one embodiment the article is resiliently biased toward a substantially linear shape. Typically the resilient bias is provided by the elastic properties of the rubber component of the article. Typically the members of the article can be manipulated into a shape required of transport, for example a box or envelope or the like and the article regains its original shape once removed from the packaging.

In another embodiment of the invention the article can be used around the edges of objects such as tables and the like. Typically the use of the flexible edging can prevent infants, toddlers and/or the infirm from injuring themselves on sharp edges and/or corners by providing a flexible barrier.

In one aspect of the invention there is provided a method of producing an article for use as a border said article including at least two substantially linear members, said members being joined together with the angle between said members being other than 180° wherein the steps include mixing synthetic and/or natural rubber with at least one other substance and moulding and/or extruding the mixture into the article.

In one embodiment the mixture is extruded rather than moulded.

In one embodiment a layer of fibrous material is added to the mixture. Typically hessian material is used. Preferably the fibrous material is laid on top and not submerged completely when the mixture of materials which form the article is being moulded.

In one embodiment double-sided tape is then applied to the article thereby allowing the article to be fixed to one or more surfaces.

Particular embodiment of the invention will now be described with reference to the following drawings, wherein:

FIG. 1 shows a prior art example of flexible beading.

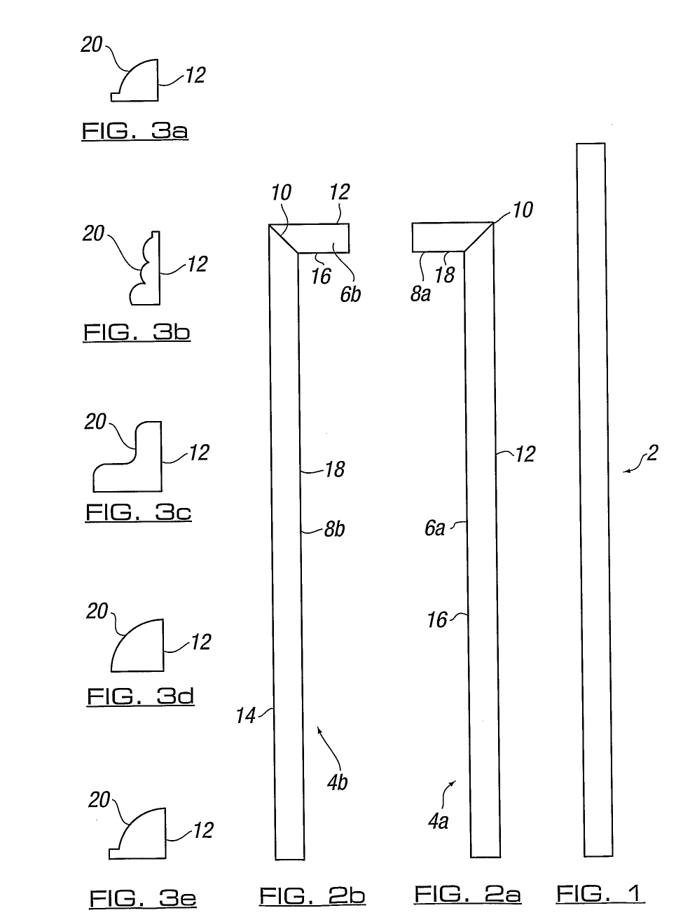

FIGS. 2a and 2b show an embodiment of the current invention;

FIGS. 3a-3e show a cross sectional profile of the flexible beading in accordance with several embodiments of the invention;

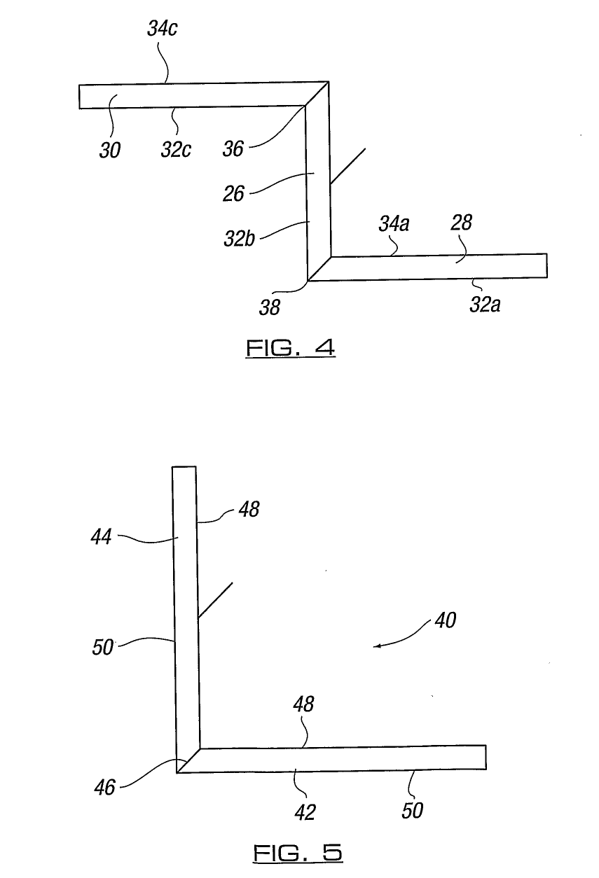

FIG. 4 shows a plan view of an embodiment of the invention;

FIG. 5 shows a plan view of an alternative embodiment of the invention; and

FIG. 6 shows a cross sectional view of one embodiment of the invention in use.

Turing firstly to FIG. 1, there is shown a plan view of an article 2. The article is a prior art example of an extruded flexible beading. It can be seen from this diagram that the flexible beading is supplied in extruded lengths that have to be cut to the correct angles to fit to the border of a room. The beading typically covers any gap between the floor and the skirting board. Typically the gap is left between the skirting and the floor for any expansion/contraction of the floor. This is particularly the case when laminate flooring is laid over an existing floor.

Turning now to FIGS. 2a and 2b which show plan views of one embodiment of the invention. In these examples, there are illustrated two examples of flexible beading 4a and 4b which are non-super-imposable mirror images of one another. The articles 4a, 4b include two members 6a, 8a and 6b, 8b joined together at one end substantially forming a right angle 10 between the members. The right angles formed 10 in this case are interior angles wherein faces 12 and 14 abut a wall and are hidden in use and faces 16 and 18 will face into a room in use. In example 4a it is the right hand member 6a that is the longest, when viewed from the front looking at the interior angle 10. In example 4b the right hand member 6b is the shortest when viewed from the same direction as 6a.

FIGS. 3a-e show cross sections through members. It can be seen that each member has a rearward vertical face 12 and outward face 20. The outward face 20, which is the visible face, has one or more concave and/or convex curves extending along the length thereof for decoration. The examples here in FIG. 3 also have a downward face 22 that typically is in contact with the floor if the article is beading, or the ceiling if the article is intended to be used as coving.

Turning to FIG. 4, which shows a preferred embodiment of the invention wherein the article 24 includes a central member 26 joined at each end thereof to peripheral members 28, 30. Each member has an outward faces 32a-c, which are visible in use, and inward faces 34a-c, which are not visible in use. The article 24 is supplied as shown and can be manipulated to fit into packaging such as liner boxes and the like. As the articles major component is typically rubber, once removed from the packaging the article regains its original shape. As can be seen in this configuration the article 24 has one interior angle 36 and one exterior angle 38. In use, the central portion can be cut, typically with a knife or a pair of scissors, to provide one interior angle and one exterior angle of flexible beading that can be fitted as required. Any gaps between the beading angles can be simply filled with flexible beading cut to the required length. As the beading is flexibly it can be fitted to angles that are not true 90° corners. This completely removes the need for mitre blocks and saws. Typically the inward faces have a layer of self adhesive to attach the members to the wall and/or floor or the like, removing the need for nails and/or glue.

FIG. 5 shows an alternative embodiment, an article 40 including two members 42 and 44 with inward facing 48 and outward facing 50 surfaces, which are joined at one end only to form a single exterior angle 46.

The illustration, FIG. 6, shows a cross section through a member similar in shape to that shown in FIG. 3e. The member has a inward facing surface 12 and a downward surface 22 which is in contact with the floor (not shown). The outward facing surface 20 is bevelled for decorative effect. Also shown in this diagram is the outermost layer of semi-submerged hessian material 52 which is added to the article when it is in the mould. The hessian provides a surface to which an adhesive material and/or layer can be adhered and can be added along with various colourings other additives to achieve the desired aesthetic appearance. The wood grain effect of the article is typically provided by the mould in which the article is made. Other additives, such as fire retardants, can also be added to the composition of the article to improve the safety features of the same.

In addition, the hessian fibres provide a surface to which a layer of self adhesive material, such as for example double sided tape, can be added to increase the ease of fitting of the article to the required surface or surfaces.

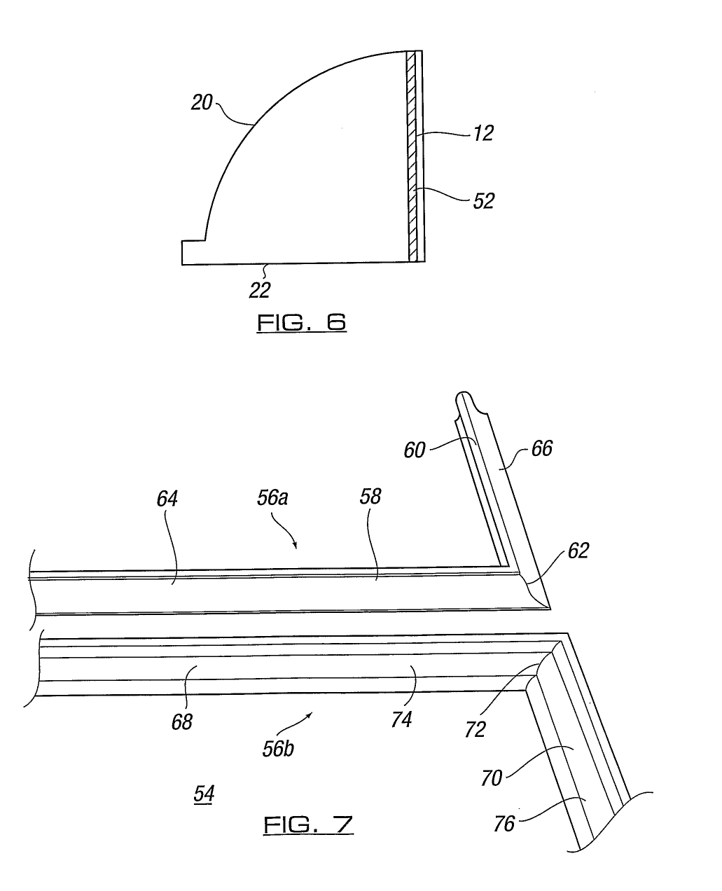

FIG. 7 shows an image of two embodiments of flexible beading 56a, 56b situated side by side on a surface 54. Turing firstly to article 56a, this shows a beading which would fit around an ‘exterior’ corner in a room in use. The article includes two members 58, 60 which are joined together at the ends in a substantially 90° angle to form an ‘exterior’ corner 62. It can be seen from this embodiment that each member 58, 60 has curved surfaces 64, 66 running along the length thereof that provide a decorative effect. In this example the curves are convex but it is appreciated that they could also be concave, or a combination thereof.

Article 56b shows beading which fits into an ‘interior’ corner of the room. This article is also includes two members 68, 70 which are joined together to form an substantially 90° interior corner 72. Both members 68, 72 also have concave convex surfaces 74, 76 running along the length thereof.

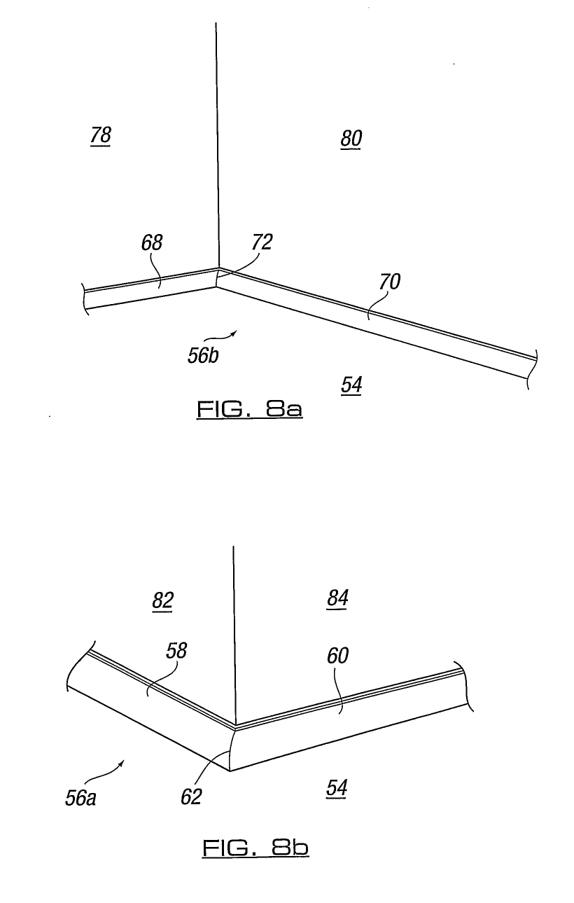

FIGS. 8a and 8b show the articles 56a and 56b in use in a room on floor surface 54 which is bordered by walls 78, 80 and 82, 84. In FIG. 8a the article 56b can be seen in use bordering an internal corner in the room as beading. In FIG. 8b the article 56a borders an exterior corner.

FIGS. 9a and 9b show articles 86, 88 in use which border the exterior angles in a room with laminate flooring 90. It can be seen that the articles cover the expansion gap (not shown) between the floor 90 and the skirting boards 92. It can also be seen that the articles have tapered ends 94, 96, which can be easily cut into said articles are can be provided pre-formed.

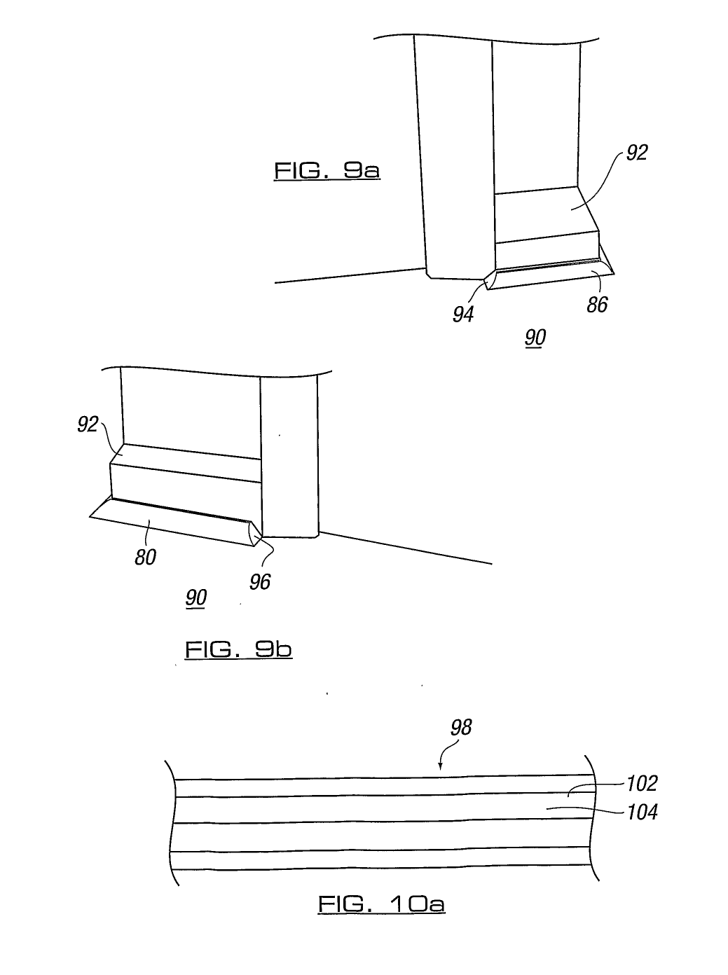

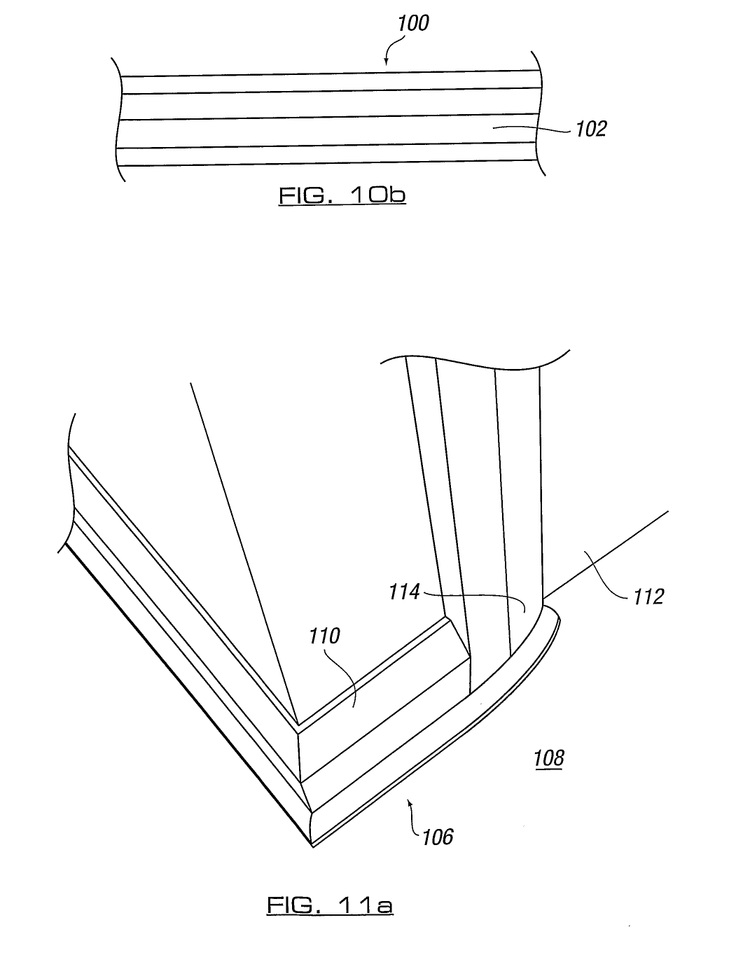

Turning now to FIGS. 10a and 10b where there are shown close-up images of articles 98, 100. The close-up images clearly show the artificial wood grain effect 102 produced on the articles. This wood grain effect gives the impression that the articles, again in this example flexible beading, are constructed from real wood. Article 98 also has an artificial wood knot 104 for an added realistic effect.

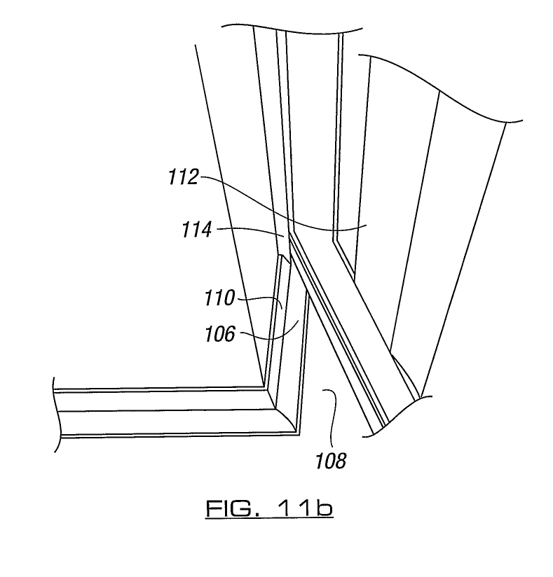

FIGS. 11a and 11b show examples of an article 106 in use. It can be seen that the article is a flexible beading which borders the edge of a room where the laminate flooring 108 meets the skirting board 110. FIG. 11a shows the door 112 in a substantially closed position and the article 106 can clearly be seen to follow the angled surface of the doorway architrave 114 closely. Following an architrave such as this is something which is very difficult to do with conventional beading. FIG. 11b shows the door 112 in the fully open condition which actually contacts and impinges the article 106. As the article is flexible however no damage is caused and the door 112 can be opened fully a number of times.

1. A beading or border article, said article including at least two substantially linear members, wherein said members are joined together such that the angle between said members is other than 180°.

2. An article according to claim 1 wherein said article includes three members, each member joined to another by at least one end thereof.

3. An article according to claim 2 wherein the article includes a central member joined at one to a first peripheral member having a first angle therebetween and the second peripheral member joined to the other end of the central member having a second angle therebetween.

4. An article according to claim 3 wherein the first angle forms an external angle and the second angle forms an internal angle or vice-versa.

5. An article according to claim 4 wherein the first angle between the central member and the first peripheral member is substantially 90° and the second angle between the central member and the second peripheral member is substantially 270°.

6. An article according to claim 4 wherein the first angle is substantially 270° and the second angle is substantially 90°.

7. An article according to claim 1 wherein the article includes at least one external facing surface exposed in use and at least one internal facing surface not exposed in use.

8. An article according to claim 7 wherein at least a portion of the internal surface is in contact with the surface onto which the article is to be attached.

9. An article according to claim 7 wherein the external surface includes at least one curve and/or bevel running substantially along the length thereof.

10. An article according to claim 4 wherein said article can be manipulated to fit adjacent surfaces to which the article is attached.

11. An article according to claim 1 wherein said article is resiliently biased to the condition in which it was originally formed.

12. An article according to claim one wherein the unattached ends of the members are tapered.

13. An article according to claim 8 wherein at least a portion of the internal facing surface of the article includes an adhesive layer and/or strip.

14. An article according to claim 1 wherein the article has a simulated wooden texture and/or colouring.

15. An article according to claim 1 wherein the article is made substantially from synthetic and/or natural rubber and at least one other substance.

16. An article according to claim 15 wherein the article is made from 70%-90% rubber and 10%-30% fire resistant and/or retardant material.

17. An article according to claim 15 wherein the article includes 0-30% wood fibre and/or 0-30% nut shell flour and/or 0-30% hessian.

18. An article according to claim 15 wherein the article contains at least one dye and/or colouring.

19. An article according to claim 1 wherein the article is located substantially around the circumference of an object to prevent persons from injuring themselves on the said object.

20. An article according to claim 1 wherein the article is provided with sufficient flexibility so as to be manipulable by a user of the article when fitting the same as a border or beading.

21. A method of producing an article for use as a border said article including at least two substantially linear members, said members being joined together with the angle between said members being other than 180° wherein the steps include mixing synthetic and/or natural rubber with at least one other substance and moulding and/or extruding the mixture into the article.

22. A method according to claim 21 wherein a layer of fibrous material is added to the mixture.
